(19) United States
(12) Patent Application Publication
(10) Pub. No.: US 2009/0286893 A1
(43) Pub. Date: Nov. 19, 2009

(54) METHOD FOR PRODUCING MULTI-LAYERED THERMOPLASTIC ELASTOMER MATERIAL

(76) Inventor: Ruey-Sheng SHIH, Rende Shiang (TW)

Correspondence Address: RABIN & Berdo, PC, 1101 14TH STREET, NW, SUITE 500, WASHINGTON, DC, 20005, US

(21) Appl. No.: 12/120,941

(22) Filed: May 15, 2008

(51) Int. Cl. C08J 9/06

(52) U.S. Cl. 521/54

(57) ABSTRACT

The present invention relates to a method of producing multi-layered thermoplastic elastomer (TPE) composition. The TPE is used to be a polymer matrix of the material. The method comprising: (A) choosing and adding a cross-linking agent to retain the thermoplastic-property of the TPE, and (B) combining different layers by using a thermal-pressing process without glue for bonding and forming a multi-layered TPE material.

### FIELD OF THE INVENTION

The invention relates to a method for producing multi-layered thermoplastic elastomer (TPE) material, and more particularly, to bond TPE layers without using glue for adhesion.

### BACKGROUND OF THE INVENTION

Plastic products are common in modern society. However, the manufacturing processes for producing plastic products have a number of disadvantages including toxic additives and the release of toxic emissions that pollute the environment and are hazardous to the human body. Furthermore, plastic materials usually are not biodegradable and constitute an environmental pollutant potentially hazardous to the human body due to the toxic additives for manufacturing the plastic products and subsequent release of toxic gas.

High-molecular weight foam is a widely used plastic and is available as TPE and thermoset elastomer. For example, ethylenevinyl acetate (EVA) copolymer products can be shaped and colored easily during late stage of processing, and the products thereof can be recovered or reused, but the elasticity and the slip-proof characteristic of EVA copolymer products are not desirable in many applications.

With reference to FIG. 1, the TPE mat (1) has two layers, comprising: an upper layer (11), a mesh layer (14) and a lower layer (12). The mesh layer (14) always used to sandwich between different layers and glued by gel. Therefore, the mesh layer (14) is utilized to fix the upper layer (11) and the lower layer (12) and to prevent the TPE mat (1) from shape changing by external force.

The disadvantages might be mitigated by mixing materials with different properties and forming a new complex material to produce the multi-layered material. The components of the complex material and their relative proportions are important to the combination of heterogeneous materials and can be difficult to effectively control.

### SUMMARY OF THE INVENTION

The main objective of the present invention is to provide a method for producing multi-layered thermoplastic elastomer (TPE) material.

The present invention relates to a method of producing multi-layered thermoplastic elastomer (TPE) composition. The TPE is used to be a polymer matrix of the material. The method comprising: (A) choosing and adding a cross-linking agent to retain the thermoplastic-property of the TPE, and (B) combining different layers by using a thermal-pressing process without glue for bonding and forming a multi-layered TPE material.

### BRIEF DESCRIPTION OF THE DRAWINGS

Many of the attendant advantages and features of this invention will become more apparent by reference to the following detailed description, when taken in conjunction with the accompanying drawings, wherein:

FIG. 1 is a cross sectional side view of a conventional TPE mat.

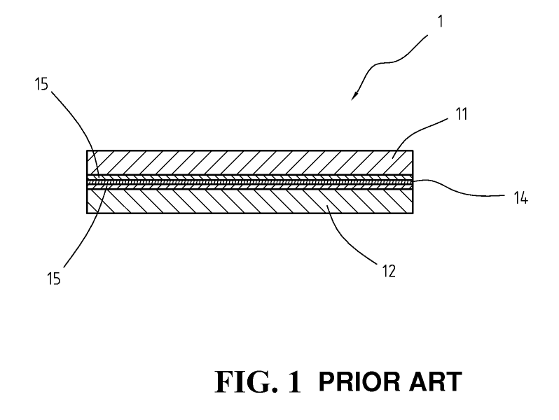

FIG. 2 is a flow chart for producing TPE material in accordance with the present invention.

FIG. 3 is a cross sectional side view of TPE material in accordance with the present invention.

### DETAILED DESCRIPTION OF THE PRESENT INVENTION

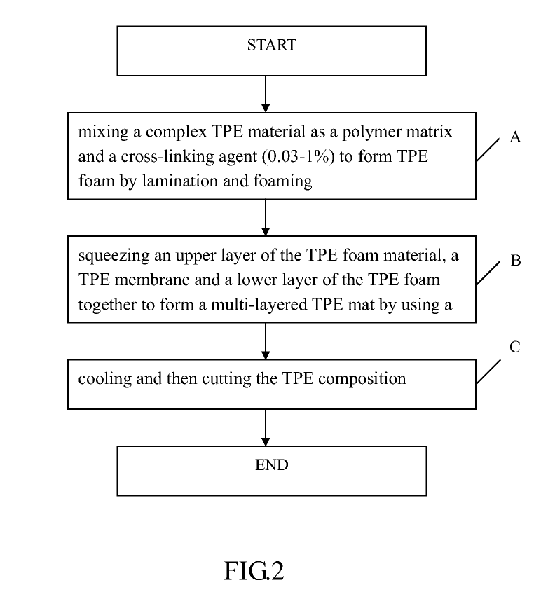

With reference to FIG. 2, a method for producing multi-layered thermoplastic elastomer (TPE) material in accordance with the present invention comprises: The TPE composition comprises at least two layers.
(A) mixing a complex TPE material as a polymer matrix and a cross-linking agent (0.03-1%) to form TPE foam by lamination and foaming;
(B) squeezing an upper layer of the TPE foam material, a TPE membrane and a lower layer of the TPE foam together to form a multi-layered TPE mat by using a thermal-pressing process; and
(C) cooling and then cutting the TPE composition.

The complex TPE material is selected from a group comprising Styrene-Butadiene-Styrene (SBS), Styrene-Isoprene-Styrene (SIS), Styrene-Ethylene-Butylene-Styrene Elastomer (SEBS), Styrene-butadiene rubber (SBR), polystyrene (PS), Acrylonitrile-Butadiene-Styrene (ABS), polyethylene (PE), high-density polyethylene (HDPE), polypropylene (PP), Acrylonitrile-styrene copolymer (AS) and any combination of the foregoing copolymers and polymers.

In various embodiments, the weight percentage of SBS, SIS or SEBS is 0-99%, SBR is 0.5-10%, PS is 0.5-40% and ABS, HDPE, PP, EVA or AS is 0-40%.

### Example 1

The complex TPE material may be SBS, PS and SBR in the quantities indicated in Table 1 and are mixed well to form TPE pellets.

TABLE 1

| Component | Content (parts) |
|---|---|
| SBS | 100 |
| PS | 9 |
| SBR | 6 |

100 parts in weight of the TPE pellets containing 87% SBS, 7.8% PS and 5.2% SBR, 5.2 parts foaming agent, 1.5 parts foaming agent additive and 0.15 parts (approximately 0.14% by weight) cross-linking agent of peroxide are mixed, and the mixture is laminated. The foaming process is carried out at 155˜165° C. and a pressure of 150 Kg/cm² to form an upper layer and a lower layer of the present invention.

Then, the TPE pellets are attached to a TPE membrane by calendars.

The preferable temperature of the thermal-pressing process is in a range from 110 to 130° C. and pressure is 20-60 kg/cm². In this example, the upper layer, the TPE membrane and the lower layer were stacked and pressed with 30 kg/cm² at 120° C. The TPE membrane is heated to a viscoelastic state, and the upper and lower layers retain thermoplastic-ability and mobility after the foaming process because a trace amount of cross-linking agent is added. Finally, the upper and lower layers are fused with the TPE membrane and then cooled and cut to form a two-layered TPE material. The characteristics of the formed TPE pellets are shown in Table 2 with the density being 0.10 g/cm³ and the hardness being 8. Furthermore, the elongation rate and the recovery rate of the second embodiment is ideal for different applications, such as mats or exercise apparatus, with the respective elongation and recovery rate values being 278% and 65%.

TABLE 2

| Items | Value |
|---|---|
| Density (g/cm³) | 0.1 |
| Hardness (Shore C) | 8 |
| Tension (Kg/cm²) | 3.16 |
| Elongation rate (%) | 278 |
| Traction rate (%) | 4.5 |
| Recovery rate (%) | 65 |
| Stress rate (%) | 96 |
| Tearing strength (Kg/cm) | 1.33 |

### Example 2

A second embodiment of the present invention comprises ingredients of the complex TPE material as shown as Table 3. The complex TPE material is mixed well and TPE pellets are formed.

TABLE 3

| Component | Content (parts) |
|---|---|
| SBS | 100 |
| PS | 79 |
| SBR | 98 |

100 parts of TPE pellets in weight containing 36% SBS, 28.5% PS and 35.4% SBR are mixed with 5.2 parts of foaming agent, 1.5 parts of foaming agent additive and 0.15 parts of cross-linking agent of peroxide selected from dicumyl peroxide or 2,5-(tert-butylperoxide)-2,5-(dimethylhexane) and the mixtures are laminated. The cross-linking agent is about 0.14%. The foaming process is conducted at 165° C. and 150 Kg/cm² to form an upper layer and a lower layer in accordance with the present invention.

Then, the TPE pellets are attached to a TPE membrane by calenders.

The preferable conditions for thermal-pressing include a temperature between 110 to 130° C. and pressure between 20˜60 kg/cm². In this example, the upper layer, the TPE membrane and the lower layer were stacked and pressed with 30 kg/cm² at 120° C. The TPE membrane is heated to a viscoelastic state, and the thermoplastic-ability and mobility of the upper layer and the lower layer are maintained after the foaming process by adding a trace amount of cross-linking agent. Finally, the upper layer and the lower layer are fused with the TPE membrane and then cooled and cut to form a two-layered TPE composition. The characteristics of the formed TPE pellets are shown as Table 4 with the density being 0.10 g/cm³ and the hardness being 22. Furthermore, the elongation rate and the recovery rate of the second embodiment is ideal for different applications, such as mats or exercise apparatus, with the respective elongation and the recovery rate values being 270% and 52%.

TABLE 4

| Items | Value |
|---|---|
| Density (g/cm³) | 0.10 |
| Hardness (Shore C) | 22 |
| Tension (Kg/cm²) | 8.10 |
| Elongation rate (%) | 270 |
| Traction rate (%) | 4 |
| Recovery rate (%) | 52 |
| Stress rate (%) | 92 |
| Tearing strength (Kg/cm) | 3.88 |

Traditionally, adding a cross-linking agent to the EVA foaming process will convert the characteristic of the TPE membrane from thermoplastic to thermosetic, and the products could not be reused. Therefore, the embodiments using a trace amount (˜0.14%) of the cross-linking agent retain the thermoplastic-ability of the TPE which overcomes the traditional shortcoming of the EVA. Furthermore, the embodiments in accordance with the present invention are lighter and less dense than PVC and CR with the respective density values being 0.2-0.36 g/cm³ and 0.24-0.28 g/cm³ and have the same density value of EVA (0.10-0.15 g/cm³). However, the multi-layered composition in accordance with the present invention can be recycled.

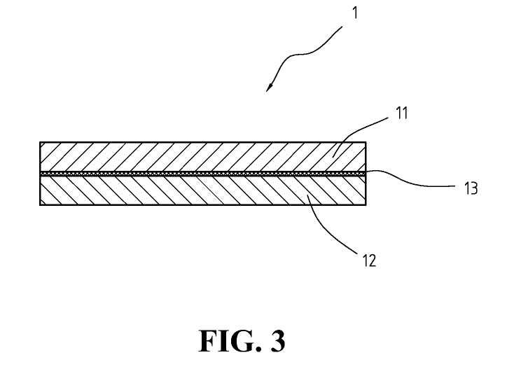

With reference to FIG. 3, another embodiment of the TPE composition in accordance with the present invention is a two-layered TPE mat (1), comprising an upper layer (11), a lower layer (12) and a TPE membrane (13). The upper layer (11) and the lower layer (12) are made of the complex TPE material being closed-cell foam. The TPE membrane (13) is mounted between the upper layer (11) and the lower layer (12). Since the TPE membrane (13) is homologous to the complex TPE material, the TPE membrane (13) will melt and fuse with the upper layer (11) and the lower layer (12) during the thermo-pressing process. Accordingly, the complex TPE material and the TPE membrane (13) are fused and bonded to each other to form a one-piece TPE mat (1). Therefore, glue is not to bond and combine the two layers (11, 12).

Even though the invention has been particularly shown and described with reference to preferred embodiments, these are merely examples to help make the invention more easily understandable and are not intended to limit the invention. That various changes, modifications, and alterations in form and details may be made therein without departing from the spirit and scope of the invention, as set forth in the following claims will be understood by those skilled in the art.

What is claimed is:

1. A method of producing multi-layered thermoplastic elastomer (TPE) composition, comprising:
(A) mixing a complex TPE material as polymer matrix and a cross-linking agent (0.03-1%) to form a TPE foam by lamination and foaming;
(B) squeezing an upper layer of the TPE foam, a TPE membrane and a lower layer of the TPE foam together to form a multi-layered TPE mat by using a thermal-pressing process; and
(C) cooling and then cutting the TPE composition.

2. The method as claimed in claim 1, wherein the TPE composition comprises at least two layers.

3. The method as claimed in claim 1, wherein the complex TPE material is selected from a group comprising Styrene-Butadiene-Styrene (SBS), Styrene-Isoprene-Styrene (SIS), Styrene-Ethylene-Butylene-Styrene Elastomer (SEBS), Styrene-butadiene rubber (SBR), polystyrene (PS), Acrylonitrile-Butadiene-Styrene (ABS), polyethylene (PE), high-density polyethylene (HDPE), polypropylene (PP), Acrylonitrile-styrene copolymer (AS) and any combination of the foregoing copolymers and polymers.

4. The method as claimed in claim 1, wherein the temperature to foam the polymer matrix and the cross-linking agent is 155˜165° C.

5. The method as claimed in claim 1, wherein the cross-linking agent is peroxide.

6. The method as claimed in claim 3, wherein the weight percentage of SBS, SIS or SEBS is 0-99%.

7. The method as claimed in claim 3, wherein the weight percentage of SBR is 0.5-10%.

8. The method as claimed in claim 3, wherein the weight percentage of PS is 0.5-40%.

9. The method as claimed in claim 3, wherein the weight percentage of ABS, HDPE, PP, EVA or AS is 0-40%.

10. The method as claimed in claim 5, wherein the peroxide selected from dicumyl peroxide or 2,5-(tert-butylperoxide)-2,5-(dimethylhexane).
